(19) United States
(12) Patent Application Publication
(10) Pub. No.: US 2008/0006721 A1
(43) Pub. Date: Jan. 10, 2008

(54) Mist nozzle

(76) Inventor: Yu-Chiung Huang, Taichung (TW)

Correspondence Address: Liberty Patent and Trademark Office, P.O. Box 590, Taichung City, 400, omitted

(21) Appl. No.: 11/480,955

(22) Filed: Jul. 6, 2006

(51) Int. Cl. B05B 1/34

(52) U.S. Cl. 239/383; 239/464; 239/491; 239/571

(57) ABSTRACT

A mist nozzle easy to disassemble comprises a combination of a body and a locking cap; a water-stopping unit having a ball stopper and a spring is configured inside the combination of the body; and a rotator is configured between the water-stopping unit and the locking cap, the rotator has a protruding contact strip and a protruding retainer disposed on one end thereof corresponding to the water-stopping unit. When the locking cap is separated from the body, the rotator is exposed, and the moment of taking the rotator out, the protruding retainer picks out the spring and the ball stopper of the water-stopping unit as well, so that the components inside the body have the convenience of departing off that is helpful for cleaning the components.

### BACKGROUND OF THE INVENTION

1. Field of the Invention

The present invention relates to a mist nozzle and, in particular to a structure of the mist nozzle. The mist nozzle may be mounted in predetermined pipes or containers and generate vapor while liquid is sprayed out of the nozzles.

2. Description of Related Art

Generally, the main structure of a mist nozzle includes a body having a rotator axially inward and a locking cap with a spout locked on one end thereof. Liquid flows through the inside of the body and is sprayed out via the spout, a state of vapor is formed by means of a small interval between the rotator and the body or a wall of the locking cap and the rotator.

In order to prevent liquid leak when the mist nozzle is not in use, a water-stopping unit, such as a combination of a ball stopper and a spring, may be configured inside the mist nozzle for stopping residual water inside the body from seeping.

However, the mist nozzle has a small volume and a configuration of the water-stopping unit and the rotator therein, impurities in the liquid tend to block the liquid flow so as to clean the mist nozzle being a must after using a period of time.

The method of clean may dismantle the components of the mist nozzle. However, since the volumes of those components are small, in addition, the impurities result in restriction on those components, the components can not be departed freely. In particular, the spring of the water-stopping unit is very inconvenient evidently due to that the spiral structure tends to make the impurities retained and to grapple the wall surfaces of the body, therefore the spring can be taken out only by way of inverting and rocking the body and even of grappling by some other means.

### SUMMARY OF THE INVENTION

In view of the difficulty in dismantling the components of a mist nozzle disclosed in prior art, for which washing is consequently difficult, the present invention discloses a mist nozzle easy to disassemble and convenient to wash.

The main objective of the present invention is to provide a mist nozzle easy to disassemble, which has a design of dismantling a rotator very easily, the rotator is coupled to the spring and the spring is coupled to the ball stopper so as to take off the rotator, the spring, and the ball stopper simultaneously, thereby fulfilling an effect of separating the components easily.

According to the mention above, the present invention comprises a combination of a body and a locking cap; a water-stopping unit having a ball stopper and a spring is configured inside the combination of the body; and a rotator is configured between the water-stopping unit and the locking cap, the rotator has a protruding contact strip and a protruding retainer disposed on one end thereof corresponding to the water-stopping unit.

When the locking cap is separated from the body, one end of the rotator is exposed to exterior. When separating the rotator from the body, the protruding retainer takes the spring and the ball stopper out of the water-stopping unit.

In the following, according to the objective, function and structural configuration disclosed in the present invention, preferred embodiments are described in association with the accompanying drawings described in details.

### BRIEF DESCRIPTION OF THE DRAWINGS

FIG. 1 is an exploded view of a first embodiment of the present invention;

FIG. 2 is a schematic combined view of the first embodiment of the present invention;

FIG. 3 is an exploded view of a second embodiment of the present invention;

FIG. 4 is a schematic combined view of the second embodiment of the present invention;

FIG. 5 is an exploded view of a third embodiment of the present invention;

FIG. 6 is a schematic combined view of the third embodiment of the present invention;

FIG. 7 is an exploded view of a fourth embodiment of the present invention;

FIG. 8 is a schematic combined view of the fourth embodiment of the present invention;

FIG. 9 is a schematic view of a state of an application of the present invention.

### DETAILED DESCRIPTION OF THE INVENTION

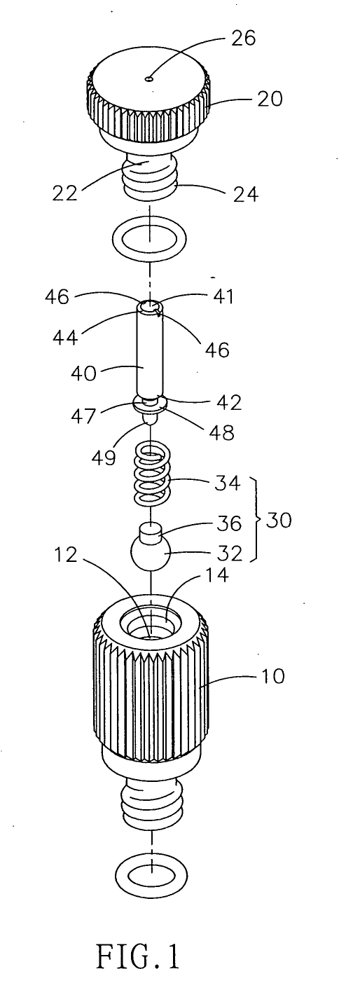

Refer to FIG. 1. The present invention discloses a mist nozzle, comprising a body (10), a locking cap (20), a water-stopping unit (30), and a rotator (40). The body (10) has a container (12) disposed axially therein, and the container (12) has an inner thread (14) on the inner surface thereof. The locking cap (20) has a protruding thread plug (22) on one end thereof, wherein the thread plug (22) has an outer thread (24) on the surface thereof. The locking cap (20) also has a penetrating spout (26) opening thereon. The water-stopping unit (30) comprises a ball stopper (32) and a spring (34). The rotator (40) has a shape of long pillar with a first end (41) and a second end (42), wherein an annular ramp (44) is formed on the surface of the rotator (40) and is close to the first end (41). Two opposite channels (46) are disposed axially along the rotator (40) from the surface of the first end (41) and an extended neck (47) is formed at the second end (42), wherein a contact strip (48) is connected to an end of the extended neck (47). In addition, the contact strip (48) has a protruding retainer (49) disposed on one side thereof.

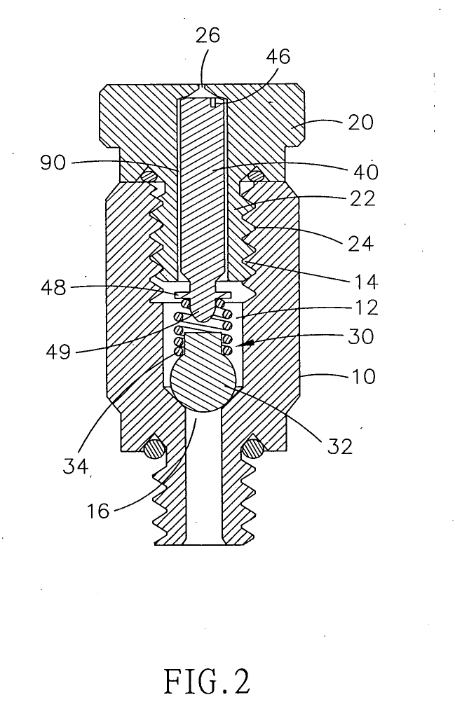

Referring to FIG. 2, the water-stopping unit (30) is configured in the container (12) of the body (10), and the ball stopper (32) leans on an intake (16), a ball stopper neck (36) is coupled to one end of the spring (34). The locking cap (20) combines with the body (10) by locking the outer thread (24) of the thread plug (22) with the inner thread (14) of the container (12). The rotator (40) is configured between the body (10) and the locking cap (20). Furthermore, the contact strip (48) disposed on one end of the rotator (40) corresponds to another end of the spring (34) and the protruding retainer (49) is coupled to another end of the spring (34). Also, the channels (46) of the rotator (40) correspond to the spout (26) and a gap (90) is formed between the channels (46) and the locking cap (20). Liquid flows in from the intake (16) to push off the ball stopper (32), and then flows through the gap (90) to cooperate in the rotation of the rotator (40), and spouts via the spout (26) with a structure of mist formed.

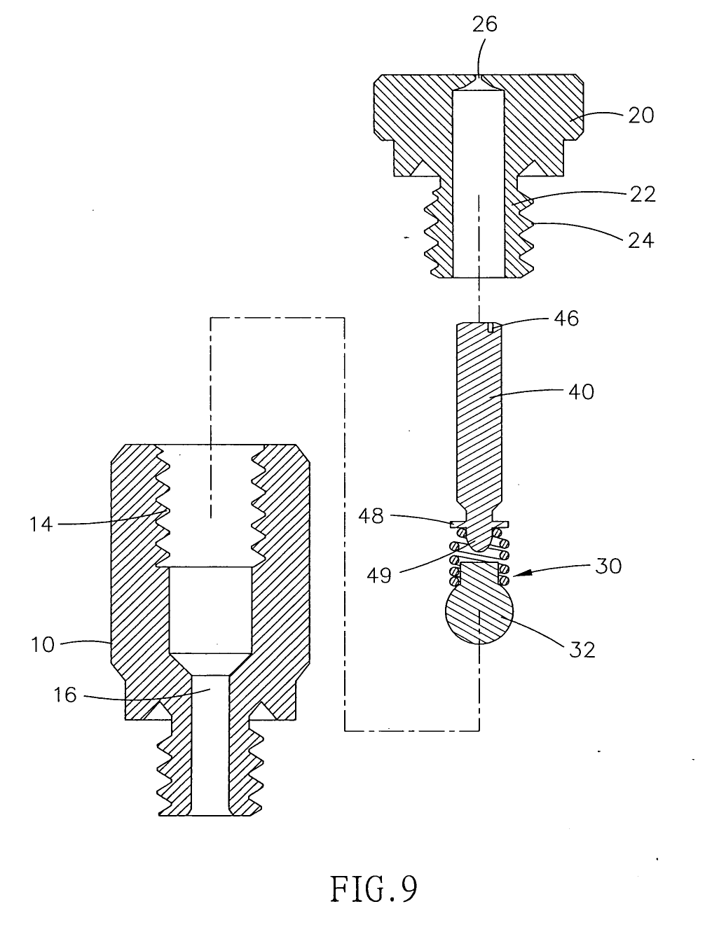

Referring to FIG. 9, since the ball stopper neck (36) of the ball stopper (32) is coupled to one end of the spring (34) and the protruding retainer (49) is coupled to another end of the spring (34), when the locking cap (20) is separated from the body (10) the user can seize the rotator (40) easily and pick out the rotator (40), the spring (34) and the ball stopper (32) at one time.

According to the present invention, the components of a mist nozzle can be separated without difficulty, which are convenient to clean for recovering the function of the mist nozzle.

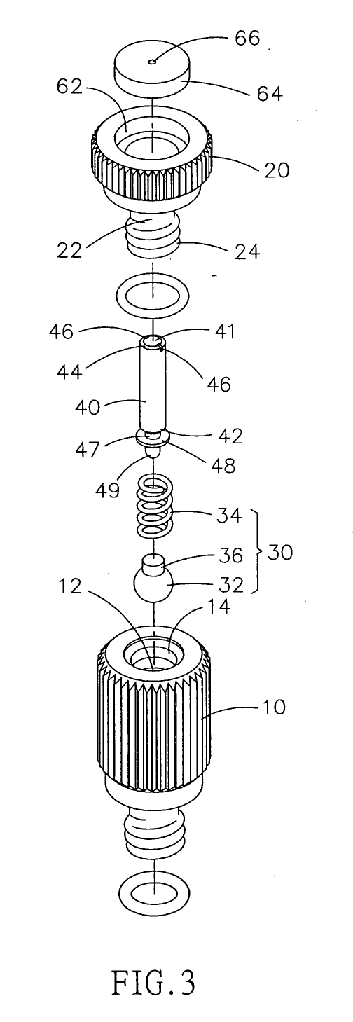

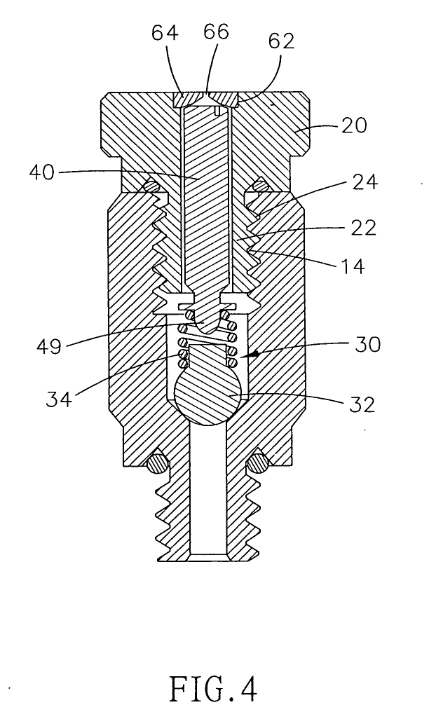

Refer to FIGS. 3 and 4, according to this embodiment, the locking cap (20) has a stopping hole (62) thereon, a stopping body (64) configured within the stopping hole (62) and on the stopping body (64), in turn, is a spout (66) opening. The locking cap (20) is fastened by way of connecting the outer thread (24) of the thread plug (22) to the inner thread (14) of the body (10), while the water-stopping unit (30) and the rotator (40) are configured within the locking cap (20) and the body (10). Since the ball stopper neck (36) of the ball stopper (32) is coupled to one end of the spring (34) and the protruding retainer (49) of the rotator (40) is coupled to another end of the spring (34), when the locking cap (20) is separated from the body (10) the user can seize the rotator (40) easily and pick out the rotator (40), the spring (34) and the ball stopper (32) simultaneously.

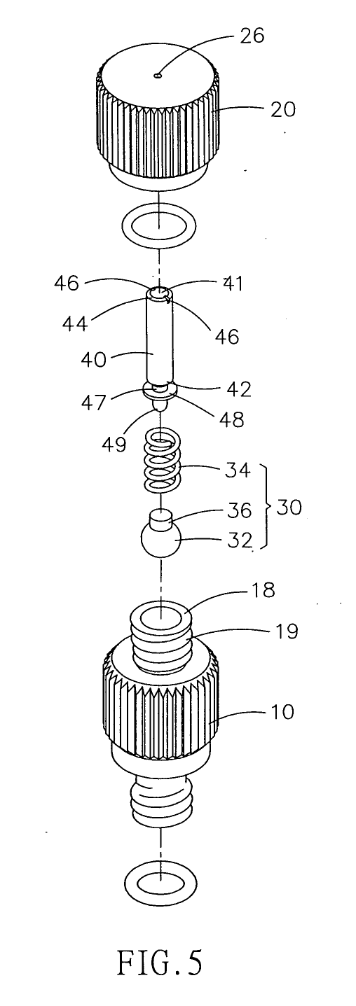

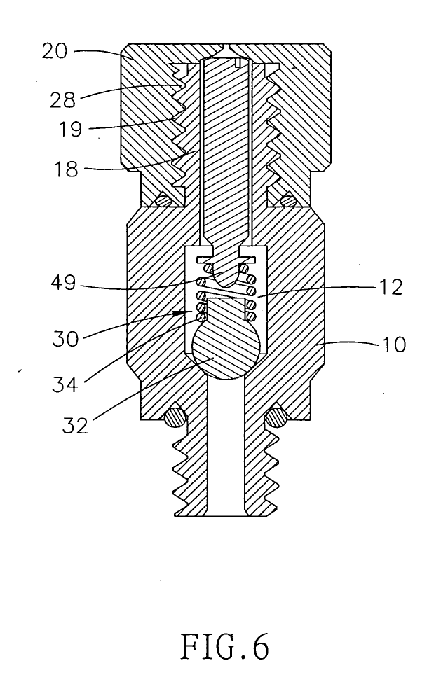

Referring to FIGS. 5 and 6, according to this embodiment, the body (10) has a protruding plug (18) on one end thereof, and the protruding plug (18) has an outer thread (19) on the surface thereof. The locking cap (20) has an inner thread (28) on the inner surface thereof. The water-stopping unit (30) is configured in the container (12) of the body (10), while the locking cap (20) is fastened by connecting the inner thread (28) to the outer thread (19) of the protruding plug (18) of the body (10). The rotator (40) is configured within the locking cap (20) and the body (10), while the protruding retainer (49) is coupled to the spring (34).

Since the ball stopper neck (36) of the ball stopper (32) is coupled to one end of the spring (34) and the protruding retainer (49) of the rotator (40) is coupled to another end of the spring (34), hence while the locking cap (20) is separated from the body (10), the user can seize the rotator (40) easily and pick out the rotator (40), the spring (34), and the ball stopper (32) at once.

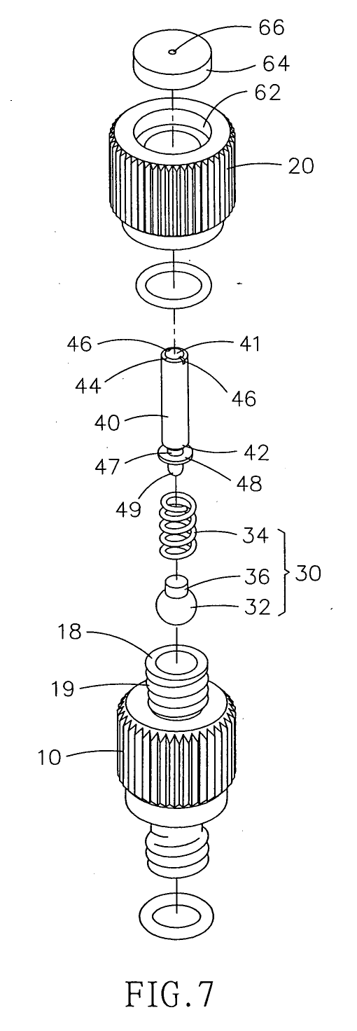

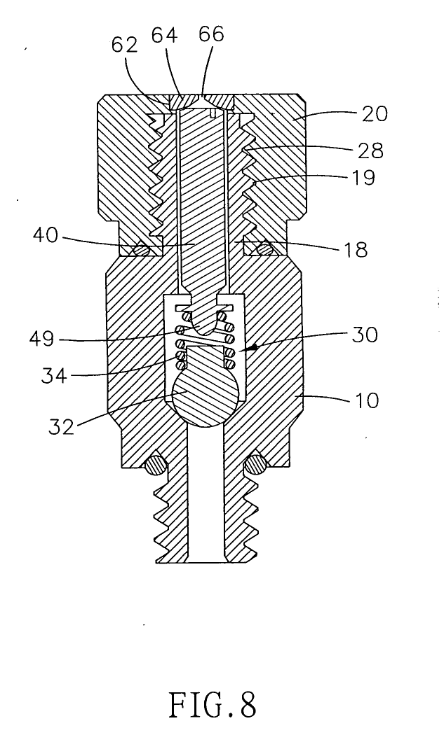

Referring to FIGS. 7 and 8, according to this embodiment, an inner thread (28) is on the surface of the inner wall of the locking cap (20), and a stopping hole (62) is on an outer surface of the locking cap (20). A stopping body (64) is configured within the stopping hole (62) and on the stopping body (64), in turn, is a spout (66) opening. The locking cap (20) is fastened by way of connecting the inner thread (28) to the outer thread (19) on the surface of the protruding plug (18) of the body (10). The water-stopping unit (30) and the rotator (40) are disposed within the locking cap (20) and the body (10).

Since the ball stopper neck (36) of the ball stopper (32) is coupled to one end of the spring (34) and the protruding retainer (49) of the rotator (40) is coupled to another end of the spring (34), hence while the locking cap (20) is separated from the body (10), the user can seize the rotator (40) easily and pick out the rotator (40), the spring (34) and the ball stopper (32) all together.

Accordingly, the rotator (40) has a protruding retainer (49) that can pick out the spring (34) from the inside of the body (10), being helpful for dismantling the components of the mist nozzle. Moreover, the locking cap (20) combines with the body (10) by locking the inner thread with the outer thread, and the locking cap (20) may have the suitable stopping body (64). Thus, the present invention has a variety of structure such that more choices are possible in the manufacturing of the products.

What is claimed is:

1. A mist nozzle easy to disassemble, comprising:
a body with a container disposed axially;
a locking cap configured at one end of the body and having a spout;
a water-stopping unit configured within the container of the body and having a ball stopper and a spring; and
a rotator configured between the water-stopping unit and the locking cap, the rotator having a shape of long pillar with a first end and a second end, wherein an annular ramp is formed on a surface of the rotator and is close to the first end of the rotator, two opposite channels are disposed axially along the rotator from a surface of the first end of the rotator, an extended neck is formed at the second end of the rotator with a contact strip being connected to an end of the extended neck, and a protruding retainer is formed on a surface of the contact strip.

2. The mist nozzle easy to disassemble according to claim 1, wherein the locking cap has a thread plug disposed with an outer thread on a surface of the thread plug, the container of the body has an inner thread on the inner surface, and the outer thread of the thread plug is locked with the inner thread of the container.

3. The mist nozzle easy to disassemble according to claim 1, wherein the locking cap has an inner thread on the inner surface, the body has a protruding plug disposed with an outer thread on a surface of the protruding plug, and the outer thread of the protruding plug is locked with the inner thread of the locking cap.

4. The mist nozzle easy to disassemble according to one of claim 1, 2 and 3, wherein the locking cap has a stopping hole disposed with a stopping body configured within the stopping hole, and the spout is opening on the stopping body.
